(19) United States
(12) Patent Application Publication
(10) Pub. No.: US 2026/0313299 A1
(43) Pub. Date: Oct. 8, 2026

(54) Feedback Canceller in a Hearing Assistance System

(71) Applicant: Legato Audio, Inc., Falmouth, MA (US)

(72) Inventor: Anand Parthasarathi, Cupertino, CA (US)

(21) Appl. No.: 19/640,282

(22) Filed: Apr. 6, 2026

Related U.S. Application Data
(60) Provisional application No. 63/784,088, filed on Apr. 5, 2025.

(51) Int. Cl. H04R 25/00; G02C 11/00

(52) U.S. Cl. CPC H04R 25/453; G02C 11/10; H04R 25/405; H04R 25/407; H04R 25/604; H04R 2430/01

(57) ABSTRACT

A feedback cancelation system for a hearing assistance system is provided. The system comprises an adaptive feedback canceller that receives input of a microphone signal from an array of microphones and estimates an acoustic path from a speaker driver back to the microphone array, wherein the adaptive feedback canceller uses the estimate to remove feedback signals from the speaker driver back to the microphone array. The system also comprises an instability estimator that compares microphone signal energy to speaker driver signal energy, wherein, responsive to the ratio of the speaker driver energy to microphone signal energy exceeding a specified threshold, the instability estimator initiates an across-the-board gain reduction into the adaptive feedback canceller.

### CROSS-REFERENCE TO RELATED APPLICATION

This application claims the benefit of U.S. Provisional Patent Application Ser. No. 63/784,088, filed Apr. 5, 2025, and entitled “Feedback Canceller in an Hearing Assistance System,” herein incorporated by reference in its entirety.

### BACKGROUND INFORMATION

### 1. Field

The present disclosure relates to hearing assistance devices, and more specifically to an open ear hearing assistance device incorporated into eyeglasses.

### 2. Background

In an open-ear hearing assistance system such as a pair of hearing aid glasses, the feedback from the speaker to microphones is problematic as there are no physical barriers separating the speech and the microphone such as an ear tip containing the speaker that fits into the ear of a user. Such open ear hearing systems can impose constraints on the acoustic system such that the feedback from the speaker driver is mitigated by reducing the acoustic output levels or narrow frequency shaping. However, this limits the amount of amplification the system can provide to a user which is not desirable.

### SUMMARY

An illustrative embodiment provides a feedback cancelation system for a hearing assistance system. The system comprises an adaptive feedback canceller that receives input of a microphone signal from an array of microphones and estimates an acoustic path from a speaker driver back to the microphone array, wherein the adaptive feedback canceller uses the estimate to remove feedback signals from the speaker driver back to the microphone array. The system also comprises an instability estimator that compares microphone signal energy to speaker driver signal energy, wherein, responsive to the ratio of the speaker driver energy to microphone signal energy exceeding a specified threshold, the instability estimator initiates an across-the-board gain reduction into the adaptive feedback canceller.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 depicts an open ear hearing device incorporated into an eyeglasses frame in which the illustrative embodiments can be implemented;

FIG. 2 depicts a block diagram of a basic feedback canceller in accordance with the prior art;

FIG. 3 depicts a block diagram of an augmented adaptive filter to which the illustrative embodiments may be applied;

FIG. 4 illustrates an augmented feedback canceller with a fast-acting canceller to augment the slower-acting adaptive filter canceller in accordance with an illustrative embodiment;

FIG. 5 is a flowchart illustrating a process for ducking gain in accordance with an illustrative embodiment;

FIG. 6 is a flowchart illustrating a process for implementing weighted thresholds for different frequency bands in accordance with an illustrative embodiment; and

FIG. 7 depicts a diagram of a state machine for providing gain ducking in accordance with an illustrative embodiment.

### DETAILED DESCRIPTION

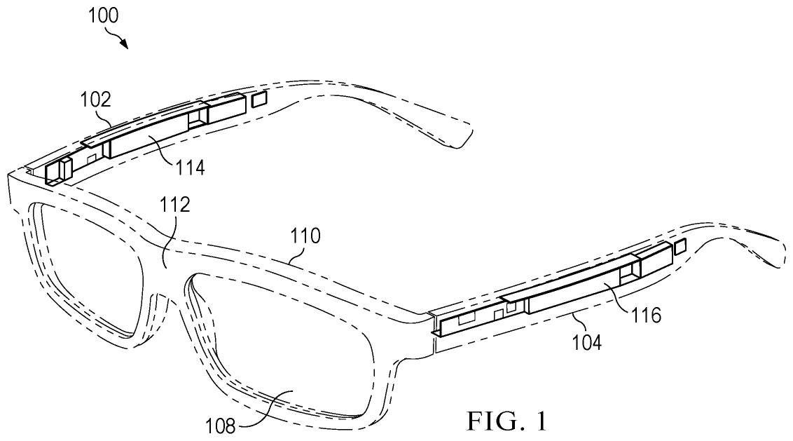

In one implementation, as shown in FIG. 1, a pair of hearing glasses 100 includes a right and left temple arm, 102, 104, that are attached to a front frame 112 that holds eyeglass lenses 108. Each of the temple arms 102, 104 includes a hearing assistance system 114, 116. Each hearing assistance system 114, 116 may include an array of two or more microphones and a speaker positioned in proximity to the user's ear. In this example, the temple arms are independently operated and powered and there are no electrical connectors or components in or along the front frame 112. The temple arms may be in wireless communication with each other to synchronize certain operations, such as volume level, left/right balance control, or playback of a spatialized audio signal (e.g., a stereo music signal streamed from a phone). Hearing glasses 100 are described in U.S. patent application Ser. No. 19/174,869, issued as U.S. Pat. No. ______, titled “Open Ear System Using Artificial Intelligence (AI) Driven Audio Signal Processing” filed Apr. 9, 2025, the entirety of which is hereby incorporated by reference.

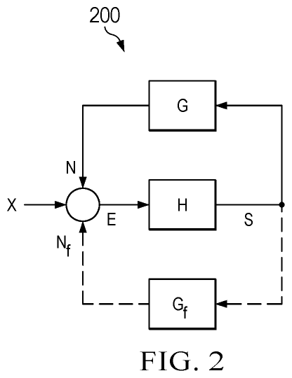

FIG. 2 depicts a block diagram of a feedback canceller in accordance with the prior art. In this schematic of the feedback canceller 200, the transfer function between the desired incoming speech, X, and signal to the speaker, S, is given by:

$$S = X ( \frac{H}{1 - H ( G - {G}_{f} )} ) \qquad Eq . 1$$

G is the actual transfer function from the speaker signal to the microphone. G_{f} is a transfer function estimated by the feedback canceller 200. It is an adaptive filter that adapts to match G. H is the audio insertion gain of the system. The denominator 1−H(G−G_{f}) in equation 1 degrades the maximum insertion gain. This denominator is known as the de-sensitivity function. One extreme example is when the de-sensitivity function approaches 0, or when H(G−G_{f}) approaches 1. As the de-sensitivity function approaches 0, the signal to the speaker(S) approaches infinity, causing instability. The de-sensitivity function can approach zero at specific frequencies, which causes the system to go unstable and squeal, howl, etc. at those frequencies. Modifying H, typically reducing its amplitude, and/or adjusting G_{f} mitigates this feedback instability.

When the acoustic path between the speaker and the microphone is time-invariant, G is fixed. In this instance, maximum insertion gain is achieved when the feedback canceller accurately matches G_{f} to G. When G_{f} and G are exactly matched, the de-sensitivity function (denominator of eq. 1) is 1, and the system is stable. In this condition, there will be no instability and absence of squeals. Hence, accurate matching of G_{f} to G is important for effective functioning of the device. However, accurate matching of G_{f} to G is limited by the adaptive filters' ability to discriminate incoming speech from the feedback speech.

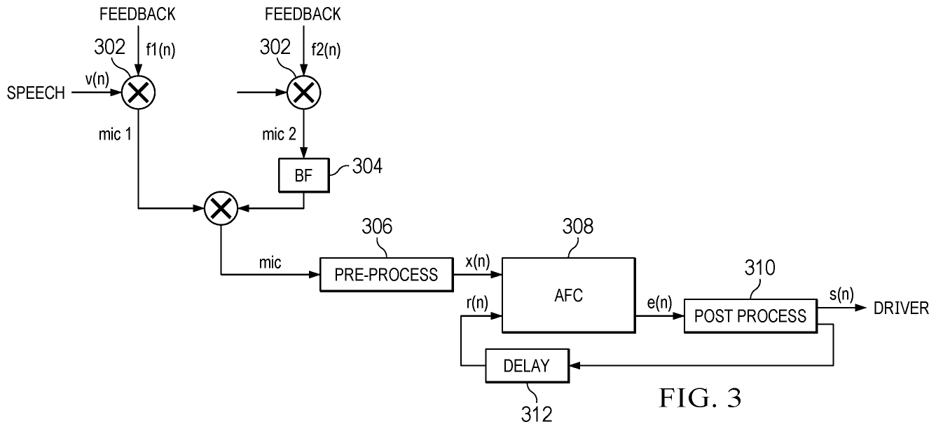

FIG. 3 depicts a block diagram of an augmented adaptive filter to which the illustrative embodiments may be applied. The adaptive filter's ability to match G and improve the stability of the system can be augmented in several ways. In one implementation, a two-microphone array 302 in each temple arm is used to form a null at the speaker in that temple arm. This null reduces the magnitude of G, which enables more stable audio insertion gain, H. To create the null, the microphones forming the array should be in close proximity to each other so that the difference between the microphone signals is close to zero. A perturbation that increases the difference between the microphone signals is an indicator that the system may become unstable.

The audio signal passes through a pre-processing step 306 that may provide filtering and gain stages, etc. The pre-processed signal then passes into an adaptive feedback canceller 308. Post-processing 310 may provide compression, filtering, etc. Delay 312 provides a reference signal for the adaptive feedback canceller 308.

The adaptive feedback canceller 308 uses the reference signal to estimate the transfer function from the speaker driver back to the microphone array 302. It uses this estimate to remove a feedback signal that came from the speaker and was fed back to the microphones. The adaptive feedback canceller 308 thereby operates to cancel the reduced G (from the microphone null) and thus further increases the achievable audio insertion gain, H.

The total microphone signal (i.e., the combined signal of the microphone array) at any instant contains two components: 1) desired signal and 2) a corrupting signal G, which is the feedback signal from the speaker back to the microphones. The components of the microphone signal also contribute respective components of the total energy of the signal, with the desired component contributing the majority of the total energy and the corrupting feedback signal contributing a relatively small energy component in normal operation.

With the added beamformer 304, equation 1 is now modified as follows:

$$S = X ( \frac{\begin{matrix}H & {\overbrace{[ 1 + B \cdot M ]}}^{additional gain}\end{matrix}}{1 - H \cdot [ {G}_{1} + B \cdot {G}_{2} - {G}_{f} ]} ) \qquad Eq . 2$$

The additional transfer functions that enter are the beamforming filter, B, and the front mic to back mic transfer function, M. G₁ and G₂ are the feedback from the speaker to the front and rear microphones, respectively, situated on the temple arm. The functioning of the adaptive feedback canceller 308 is positively enabled when function B is designed such that:

$$\vert {G}_{1} + B \cdot {G}_{2} \vert < G$$

This enables the adaptive feedback canceller 306 to cancel a reduced function. Effectively this means that the new de-sensitivity function is:

$$1 - H ( {G}_{1} + B \cdot {G}_{2} - {G}_{f} ) ,$$

and a higher value of H is needed to make this function go to 0 than the previous de-sensitivity function 1−H(G−G_{f}). Therefore, the system can achieve higher amplification of the incoming speech before it goes unstable and squeals.

In the above the functions G₁ and G₂ are fixed, i.e. time-invariant. If the acoustic path between the speaker and the microphones is perturbed it will change these functions. This disturbs the de-sensitivity function. As a result, 1−H(G₁+B·G₂−G_{f}) can become 0 and make the system unstable thereby causing it to generate squeals.

The adaptive feedback canceller 308 will react to this change in acoustic path and generate a new G_{f} to restore the stability of the system. However, this change will not be instantaneous (e.g., a few seconds). It is also not guaranteed that |G₁+B·G₂|<G since B was designed for the un-perturbed acoustic path. The net effect may be sustained instability and squealing of the system.

The adaptive feedback canceller 308 removes the corrupting feedback signal using an error estimation metric. The error estimation metric is defined as the expected value of the difference between energy of the total microphone signal and the energy of the corrupting feedback signal predicted by the adaptive feedback canceller. The goal of the adaptive feedback canceller is to reproduce the corrupting feedback signal and subtract it from the incoming total microphone signal, resulting in an output that is only the desired signal, which has slightly lower energy than the incoming signal in normal operation. By minimizing the error, the adaptive feedback canceller 308 effectively removes the feedback coming back into the system.

Minimizing the error is accomplished by adjusting the respective weights of filter taps (samples). The number of filter taps (e.g., 64, 256, etc.) is what the adaptive feedback canceller 308 has to model. A decorrelator inside the adaptive feedback canceller 308 ensures that the filter does not perform an energy minimization by modelling the desired input signal rather than the feedback signal. If the desired speech input signal is high, and the adaptive feedback canceller 308 were to model that instead of the feedback signal, the incoming speech signal component would be lost. With the decorrelator in place, the adaptive feedback canceller 308 adapts the weight only to model the feedback signal until the error is minimized, thereby creating a stable state. Once the adaptive feedback canceller 308 reaches a stable state, it will stop adapting.

If a perturbation is introduced, the adaptive feedback canceller 308 has to perform the same minimization process again because there is a resultant difference in energy between the input side and output side, which disturbs the error metric. The adaptive feedback canceller 308 therefore has to adapt and create a new filter to match the perturbation and settle into that new level of energy.

Examples of perturbations include the user moves or removes the device, a finger partially obscures a microphone or speaker, something accidentally taps the device, etc. It should be noted that such perturbations are more likely to occur with an open ear hearing assistance device such as hearing glasses 100 than traditional in-ear hearing aids in which the device remains stationary within the user's ear and is less accessible to incidental contact.

The time required for the adaptive feedback canceller 308 to settle into the new energy level in response to a perturbation depends on the number of filter taps it uses. For example, if the adaptive feedback canceller 308 uses 64 filter taps it has to recalculate and reassign those values for all 64 taps, which will typically take on the order of 3-5 seconds to converge and settle down.

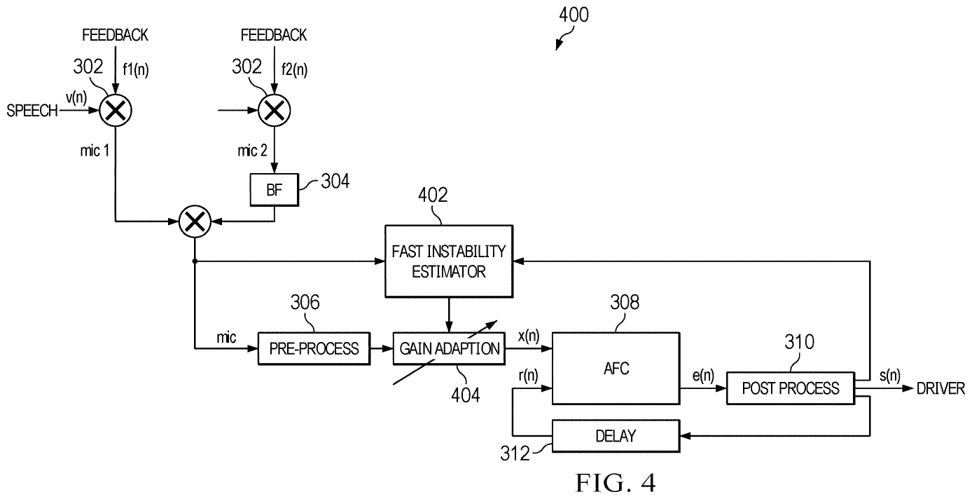

FIG. 4 illustrates an augmented feedback canceller with a fast-acting canceller to augment the slower-acting adaptive filter canceller, such as the adaptive filter feedback system shown in FIG. 3. Feedback cancelling system 400 may be implemented in hearing assistance systems 114, 116 in the temple arms 102, 104 of hearing glasses 100. The incorporation of feedback cancelation into an open ear eyeglass hearing assistance system is described in U.S. Pat. No. ______ referenced above.

To bring the system back to stability quickly, the processing gain H can be reduced such that the de-sensitivity function 1−H(G₁+B·G₂−G_{f}) remains above 0 even with the perturbed G₁ and G₂ and the incorrect G_{f}.

To reduce H quickly, fast instability estimator 402 observes the system for the onset of instability. The system is observed at two points, at the output of the beamformer 304 and at the end of the processing chain where the signal is sent to the speaker from post-processing 310. In the un-perturbed state, the beamformed signal contains the feedback signal G₁+B·G₂. By design this feedback signal is a small component of the beamformed signal in normal operation.

In the presence of perturbation of the acoustic path, this feedback signal increases in magnitude. To remove the effect of incoming speech level on this signal (e.g., the introduction of a sudden, loud desired speech signal), the beamformed signal is normalized by the speaker signal S. Hence the fast instability estimator 402 observes the following energy comparison metric (8):

$$δ = \frac{{[ {G}_{1} + B \cdot {G}_{2} ]}_{RMS}}{{S}_{RMS}}$$

where G₁ is feedback from the speaker to the front microphone, G₂ is feedback from the speaker to the rear microphone, S is the signal to the speaker, and B is the beamforming filter. The subscript RMS refers to the root mean square value of the signal. The RMS values of the numerator and denominator terms of this energy comparison metric are calculated over identical time duration. For example, if the numerator RMS is calculated over 64 samples, the denominator RMS is also calculated over the same 64 samples. This would mean, if there is a processing delay between the numerator signal and denominator signal, then a corresponding delayed denominator signal is used in calculating the energy comparison metric.

A threshold is set for the energy comparison metric to trigger a flag for ducking the gain H, which is performed by a gain adaptation stage 404. Gain adaptation stage 404 immediately (e.g., on the order of milliseconds) reduces the gain H across all operating frequencies to keep the system stable while giving the adaptive feedback canceller 308 time to catch up and adjust to the perturbation as described above.

The fast instability estimator 402 only has to look at δ, a metric of the overall energy inside the system, which is a faster calculation than the error minimization between ingoing and outgoing signals, which allows the fast instability estimator 402 to respond more quickly than the adaptive feedback canceller 308.

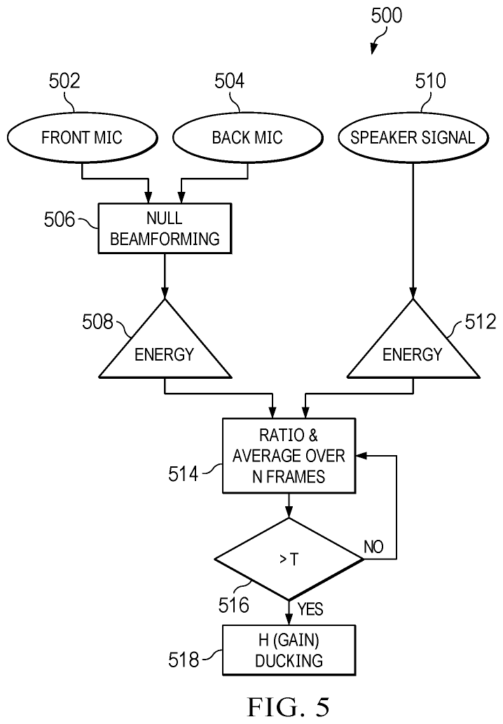

FIG. 5 is a flowchart illustrating a process for ducking gain in accordance with an illustrative embodiment. Process 500 can be implemented with a digital fast instability estimator 402.

Signals from the front microphone 502 and rear microphone 504 are combined in a null beamforming step 506. The resulting microphone signal energy 508 is then measured.

Concurrently, the speaker signal 510 is received, and the speaker signal energy 512 is measured.

At the energy comparison stage 514, the fast instability estimator calculates the ratio δ between the microphone signal energy 508 and speaker signal energy 512 and averages it over a specified number (N) of frames. Energy calculation methods may include the sum of squared sample values over N frames (e.g., 32 samples) or operations such as root mean square (RMS) or the Teager-Kaiser energy operator (TKEO). The number N of frames for averaging is determined according to the desired speed of gain reduction. For example, for the 16 kHz operation of the device, decisions are made within 10 msec (N=5) to avoid audible instabilities. A band-pass filter may be built into the averaging process to selectively monitor frequency regions vulnerable to generate instability due to acoustic perturbations.

The fast instability estimator determines whether the resulting energy comparison metric δ exceeds a prespecified threshold 516. If the energy comparison metric does not exceed the threshold, the fast instability estimator continues to compare incoming microphone and speaker signal energies.

If the energy comparison metric δ exceeds the threshold, the output of the energy comparison metric directly triggers the gain ducking 518 to reduce gain across the board. This gain ducking acts as an “emergency” mechanism in cases where an extreme acoustic perturbation triggers a squeal.

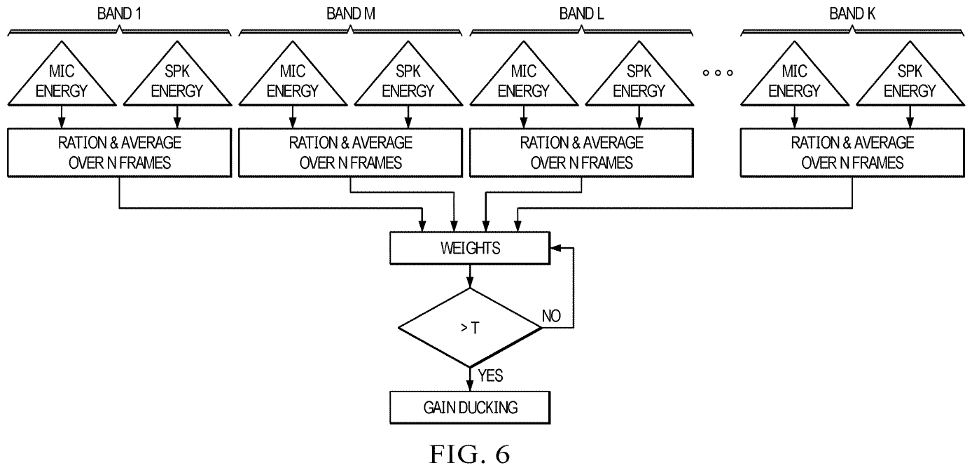

FIG. 6 is a flowchart illustrating a process for implementing weighted thresholds for different frequency bands in accordance with an illustrative embodiment. In this embodiment, multiple parallel decision branches are built using different frequency bands and thresholds to apply the ducking similar to the energy calculations in process 500 in FIG. 5.

These bands may use different averaging schemes. A decision logic consisting of a simple OR gate or weighted threshold, as shown in the present example, may further be applied from the multiple decisions to generate the trigger for ducking.

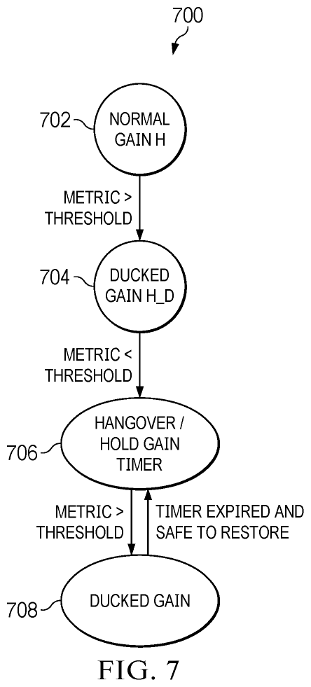

FIG. 7 depicts a diagram of a state machine for providing gain ducking in accordance with an illustrative embodiment. The state machine 700 is built for the gain ducking to provide a “hang-over” time.

The state machine 700 starts with normal gain H 702. If the energy comparison metric δ exceeds the threshold, the system transitions to a state of ducked gain H_D 704 as described above.

When the energy comparison metric falls back below the threshold the hangover state 706 keeps the system in a state of reduced gain and allows the adaptive filter to adjust itself to the perturbed acoustic state, typically 500 milliseconds. The state machine 700 then starts to release the gain to test the stability of the system. If it observes that the energy ratio is still above the threshold, the system is not stable yet, and the state machine 700 goes back to the ducked mode 708 for another time interval (half a second).

Only when the hang-over time has elapsed and the system is stable does the state machine fully release the gain.

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The description of the different illustrative embodiments has been presented for purposes of illustration and description and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A feedback cancelation system for a hearing assistance system, the feedback cancelling system comprising:
an adaptive feedback canceller that receives input of a microphone signal from an array of microphones and estimates an acoustic path from a speaker driver back to the microphone array, wherein the adaptive feedback canceller uses the estimate to remove feedback signals from the speaker driver back to the microphone array; and
an instability estimator that compares microphone signal energy to speaker driver signal energy, wherein, responsive to the ratio of the speaker driver energy to microphone signal energy exceeding a specified threshold, the instability estimator initiates an across-the-board gain reduction into the adaptive feedback canceller.

2. The feedback cancelation system of claim 1, wherein the across-the-board gain reduction is maintained until the adaptive feedback canceller has adjusted to the speaker driver energy.

3. The feedback cancelation system of claim 2, wherein the across-the-board gain reduction is held for at least 500 milliseconds before releasing gain to test system stability.

4. The feedback cancelation system of claim 1, wherein calculating the ratio microphone signal energy to speaker driver signal energy comprises at least one of:
sum of squared sample values over N frames;
root mean square; or
the Teager-Kaiser energy operator.

5. The feedback cancelation system of claim 4, wherein the number N of frames for averaging is determined according to a desired speed of gain reduction.

6. The feedback cancelation system of claim 1, further comprising a band-pass filter to selectively monitor frequency regions vulnerable to generate instability due to acoustic perturbations.

7. The feedback cancelation system of claim 6, wherein the instability estimator compares microphone signal energy to speaker driver signal energy in parallel for different frequency bands and respective thresholds.

8. The feedback cancelation system of claim 7, wherein the instability estimator further applies a weighted threshold to a combination of energy comparisons for the different frequency bands to generate a trigger for the across-the-board gain reduction.

9. The feedback cancelation system of claim 7, wherein the instability estimator further applies an OR gate to a combination of energy comparisons for the different frequency bands to generate a trigger for the across-the-board gain reduction.

10. The feedback cancelation system of claim 1, wherein the hearing assistance system is incorporated into eyeglasses.

11. An eyewear device, comprising:
a left and right eyewear stem, each comprising:
a first microphone and a second microphone;
a speaker;
an adaptive feedback canceller that receives input of a null beamforming microphone signal from the first and second microphones and estimates an acoustic path from the speaker back to the first and second microphones, wherein the adaptive feedback canceller uses the estimate to remove feedback signals from the speaker back to the first and second microphones;
an instability estimator that compares microphone signal energy to speaker signal energy, wherein, responsive to the ratio of the speaker signal energy to microphone signal energy exceeding a specified threshold, the instability estimator initiates an across-the-board gain reduction into the adaptive feedback canceller; and
a front face capable of holding a pair of eyewear lenses, wherein the front face lacks an electrical conductor connecting the right and left eyewear stem.

12. The eyewear device of claim 11, wherein the across-the-board gain reduction is maintained until the adaptive feedback canceller has adjusted to the speaker driver energy.

13. The eyewear device of claim 12, wherein the across-the-board gain reduction is held for at least 500 milliseconds before releasing gain to test system stability.

14. The eyewear device of claim 11, wherein calculating the ratio microphone signal energy to speaker driver signal energy comprises at least one of:
sum of squared sample values over N frames;
root mean square; or
the Teager-Kaiser energy operator.

15. The eyewear device of claim 14, wherein the number N of frames for averaging is determined according to a desired speed of gain reduction.

16. The eyewear device of claim 11, further comprising a band-pass filter to selectively monitor frequency regions vulnerable to generate instability due to acoustic perturbations.

17. The eyewear device of claim 16, wherein the instability estimator compares microphone signal energy to speaker driver signal energy in parallel for different frequency bands and respective thresholds.

18. The eyewear device of claim 17, wherein the instability estimator further applies a weighted threshold to a combination of energy comparisons for the different frequency bands to generate a trigger for the across-the-board gain reduction.

19. The eyewear device of claim 17, wherein the instability estimator further applies an OR gate to a combination of energy comparisons for the different frequency bands to generate a trigger for the across-the-board gain reduction.

20. An open ear hearing assistance device, comprising:
a front face capable of holding a pair of eyewear lenses;
a left and right eyewear stem connected to the front face, each comprising:
an array of microphones;
a speaker;
an adaptive feedback canceller that removes feedback signals from the speaker back to the array of microphones; and
an instability estimator that compares microphone signal energy to speaker signal energy, wherein, responsive to the ratio of the speaker signal energy to microphone signal energy exceeding a specified threshold, the instability estimator initiates an across-the-board gain reduction into the adaptive feedback canceller, wherein the across-the-board gain reduction is maintained until the adaptive feedback canceller has adjusted to the speaker driver energy.
